(19) United States
(12) Patent Application Publication
(10) Pub. No.: US 2018/0299990 A1
(43) Pub. Date: Oct. 18, 2018

(54) CAPACITIVE TOUCH PANEL

(71) Applicant: Raydium Semiconductor Corporation, Hsinchu (TW)

(72) Inventors: Chang-Ching CHIANG, Taichung City (TW); Chen-Wei YANG, Hsinchu City (TW)

(21) Appl. No.: 15/952,553

(22) Filed: Apr. 13, 2018

Related U.S. Application Data
(60) Provisional application No. 62/485,464, filed on Apr. 14, 2017.

(51) Int. Cl. G06F 3/044; G06F 3/041

(52) U.S. Cl. CPC G06F 3/044; G06F 3/0412

(57) ABSTRACT

A capacitive touch panel is disclosed. The capacitive touch panel includes a plurality of pixels. A laminated structure of each pixel includes a substrate, a self-emissive layer, an encapsulation layer, a loading reduce layer and a conductive layer from bottom to top. The self-emissive layer is disposed above the substrate. The encapsulation layer opposite to the substrate is disposed above the self-emissive layer. The loading reduce layer is disposed above the self-emissive layer. The conductive layer is disposed above the loading reduce layer.

### BACKGROUND OF THE INVENTION

### 1. Field of the Invention

The invention relates to a display; in particular, to a capacitive touch panel.

### 2. Description of the Prior Art

In recent years, with the demand for light and thin devices, in the manufacturing process of self-luminous touch panels, the thickness of the encapsulation layer will be reduced. Thus, no matter in in-cell type, on-cell type or plug-in type self-luminous touch panels, the distance between the touch sensing layer and the self-emissive layer is shortened, thereby causing a large capacitive load between the touch sensing layer and the self-emissive layer.

In the self-luminous touch panel, since the self-luminous pixels need to continuously supply current, the electrode of the self-emissive layer cannot be floated, so that the capacitive effect between the touch sensing layer and the self-emissive layer cannot be reduced and the RC loading will become larger. Therefore, when the touch sensing is driven, the touch sensing electrodes fail to be fully charged in a short time, so that the upper limit of driving frequency of touch sensing will be reduced, and even the touch sensing performance of the self-luminous touch panel will be deteriorated.

### SUMMARY OF THE INVENTION

Therefore, the invention provides a capacitive touch panel to overcome the above-mentioned problems in the prior art.

An embodiment of the invention is a capacitive touch panel. In this embodiment, the capacitive touch panel includes a plurality of pixels. A laminated structure of each pixel includes a substrate, a self-emissive layer, an encapsulation layer, a loading reduce layer and a conductive layer from bottom to top. The self-emissive layer is disposed above the substrate. The encapsulation layer opposite to the substrate is disposed above the self-emissive layer. The loading reduce layer is disposed above the self-emissive layer. The conductive layer is disposed above the loading reduce layer.

In an embodiment, the conductive layer is used as touch sensing electrode suitable for mutual-capacitive touch sensing technology or self-capacitive touch sensing technology.

In an embodiment, the self-emissive layer includes an organic light-emitting diode (OLED) laminated structure.

In an embodiment, the conductive layer is disposed under the encapsulation layer.

In an embodiment, the conductive layer and the loading reduce layer are insulated from each other; the loading reduce layer and the self-emissive layer are insulated from each other.

In an embodiment, the conductive layer is disposed above the encapsulation layer.

In an embodiment, the loading reduce layer is disposed between the conductive layer and the encapsulation layer, and the conductive layer and the loading reduce layer are insulated from each other.

In an embodiment, the loading reduce layer is disposed under the encapsulation layer, and the loading reduce layer and the self-emissive layer are insulated from each other.

In an embodiment, the capacitive touch panel further includes a cover lens disposed above the conductive layer.

In an embodiment, the loading reduce layer is disposed under the encapsulation layer, and the loading reduce layer and the self-emissive layer are insulated from each other.

In an embodiment, the loading reduce layer is disposed above the encapsulation layer, and the loading reduce layer and the conductive layer are insulated from each other.

In an embodiment, the capacitive touch panel includes a polarizer disposed between the encapsulation layer and the cover lens.

In an embodiment, the polarizer is disposed between the loading reduce layer and the conductive layer.

In an embodiment, the polarizer is disposed between the encapsulation layer and the loading reduce layer.

In an embodiment, the loading reduce layer, formed as a whole sheet of transparent electrode, overlaps the conductive layer and the self-emissive layer in vertical direction.

In an embodiment, the loading reduce layer is divided into a plurality of blocks and each block overlaps a part of the conductive layer in vertical direction.

In an embodiment, the conductive layer and the loading reduce layer are formed as transparent electrode or metal electrode in mesh shape.

In an embodiment, the conductive layer in mesh shape and the loading reduce layer in mesh shape are aligned with each other in vertical direction.

In an embodiment, the conductive layer in mesh shape and the loading reduce layer in mesh shape are only partially overlapped with each other in vertical direction.

In an embodiment, the conductive layer or the loading reduce layer is formed as transparent electrode or metal electrode in mesh shape, and a floating electrode is disposed in void regions of the mesh shape.

In an embodiment, when the conductive layer is driven by a touch driving signal to be a touch sensing electrode, the loading reduce layer is also driven by a loading reduce driving signal simultaneously at least for a part of time, and the loading reduce driving signal and the touch driving signal have the same frequency and the same phase.

In an embodiment, the loading reduce driving signal is an AC signal or a touch electrode related signal.

In an embodiment, the loading reduce layer is in floating state for another part of time.

In an embodiment, when the conductive layer is driven by a touch driving signal to be a touch sensing electrode, each block of the loading reduce layer, corresponding to the part of the conductive layer overlapped, is driven by a loading reduce driving signal in a partitioning way, and the loading reduce driving signal and the touch driving signal have the same frequency and the same phase.

Compared to the prior arts, the capacitive touch panel of the invention can be used in any self-luminous display (e.g., the OLED display, but not limited to this) and suitable for mutual-capacitive touch sensing technology and self-capacitive touch sensing technology. The capacitive touch panel of the invention can provide novel laminated structure and layout to effectively reduce parasitic capacitance and touch driving loading. Therefore, the touch sensing driving frequency and signal-to-noise ratio of the capacitive touch panel can be increased and the entire performance of the capacitive touch panel can be also enhanced.

The advantage and spirit of the invention may be understood by the following detailed descriptions together with the appended drawings.

### BRIEF DESCRIPTION OF THE APPENDED DRAWINGS

FIG. 1˜FIG. 5 illustrate schematic diagrams of the laminated structure of the pixel of the capacitive touch panel in different embodiments of the invention respectively.

FIG. 6 illustrates a schematic diagram of the loading reduce layer formed as a whole sheet of transparent electrode and overlapping the conductive layer and the self-emissive layer in vertical direction.

FIG. 7 illustrates a schematic diagram of the loading reduce layer divided into a plurality of blocks and each block overlapping a part of the conductive layer in vertical direction.

FIG. 8A illustrates a schematic diagram of the conductive layer in mesh shape and the loading reduce layer in mesh shape aligned with each other in vertical direction.

FIG. 8B illustrates a schematic diagram of only one of the conductive layer and the loading reduce layer formed in mesh shape.

FIG. 9A illustrates a schematic diagram of the conductive layer and the loading reduce layer both formed in mesh shape and a floating electrode disposed in void regions of the mesh shape.

FIG. 9B illustrates a schematic diagram of the loading reduce layer formed in mesh shape and a floating electrode disposed in void regions of the mesh shape.

FIG. 10 illustrates a schematic diagram of the loading reduce driving signal and the touch driving signal having the same frequency and the same phase.

FIG. 11 illustrates a schematic diagram of the loading reduce layer divided into blocks and the blocks can be driven in a partitioning way.

### DETAILED DESCRIPTION OF THE INVENTION

A preferred embodiment of the invention is a capacitive touch panel. In practical applications, the capacitive touch panel can be used in any self-luminous display (e.g., the OLED display, but not limited to this) and suitable for mutual-capacitive touch sensing technology and self-capacitive touch sensing technology. The touch sensing layer of the capacitive touch panel is formed by a conductive material. The touch sensing layer can be formed under the encapsulation layer, in the encapsulation layer, above the encapsulation layer in the display module through the integration technology or the touch sensing layer can be adhered on the display module through the plug-in technology.

In this embodiment, the capacitive touch panel includes a plurality of pixels. A laminated structure of each pixel includes a substrate, a self-emissive layer, an encapsulation layer. a loading reduce layer and a conductive layer from bottom to top. The self-emissive layer is disposed above the substrate. The encapsulation layer opposite to the substrate is disposed above the self-emissive layer. The loading reduce layer is disposed above the self-emissive layer. The conductive layer is disposed above the loading reduce layer.

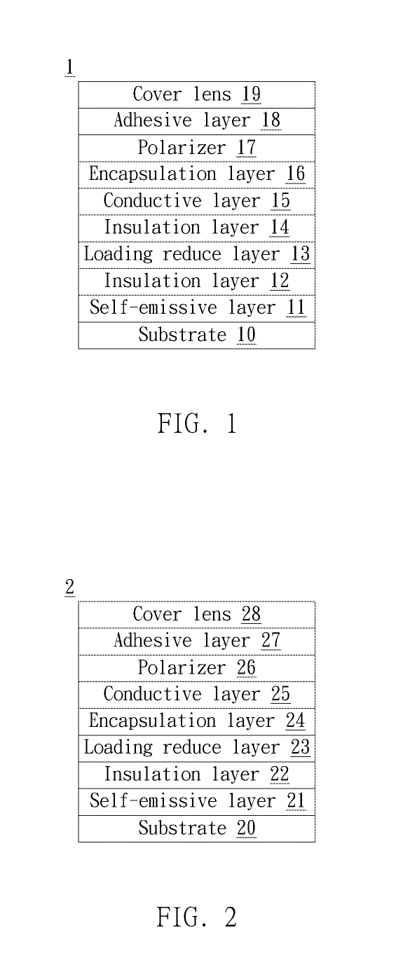

Please refer to FIG. 1˜FIG. 5. FIG. 1˜FIG. 5 illustrate schematic diagrams of the laminated structure of the pixel of the capacitive touch panel in different embodiments of the invention respectively. Wherein, the laminated structure shown in FIG. 1 belongs to the in-cell type capacitive touch panel; the laminated structure shown in FIG. 2 and FIG. 3 belongs to the on-cell type capacitive touch panel; the laminated structure shown in FIG. 4 and FIG. 5 belongs to the one glass solution (OGS) type capacitive touch panel.

In an embodiment, as shown in FIG. 1, the laminated structure of the pixel of the in-cell capacitive touch panel includes a substrate 10, a self-emissive layer 11, an insulation layer 12, a loading reduce layer 13, an insulation layer 14, a conductive layer 15, an encapsulation layer 16, a polarizer 17, an adhesive layer 18 and a cover lens 19 from bottom to top. The self-emissive layer 11 is disposed above the substrate 10. The encapsulation layer 16 opposite to the substrate 10 is disposed above the self-emissive layer 11. The loading reduce layer 13 is disposed above the self-emissive layer 11. The conductive layer 15 is disposed above the loading reduce layer 13 and under the encapsulation layer 16. The insulation layer 12 is disposed between the self-emissive layer 11 and the loading reduce layer 13. The insulation layer 14 is disposed between the loading reduce layer 13 and the conductive layer 15. The polarizer 17 is disposed between the encapsulation layer 16 and the adhesive layer 18. The adhesive layer 18 is disposed between the polarizer 17 and the cover lens 19.

In practical applications, the self-emissive layer 11 can include an organic light-emitting diode (OLED) laminated structure, which can include, for example, an anode, a hole injection layer, a hole transport layer, an organic light-emitting layer, an electron transport layer, an electron injection layer, and a cathode, etc., but not limited to this. The conductive layer 15 can be formed under the encapsulation layer 16 using an integration technology. The conductive layer 15 can be driven by a touch driving signal as a touch sensing electrode, and can be applied to self-capacitive touch sensing technology or mutual-capacitive touch sensing technology.

The loading reduce layer 13 is disposed between the self-emissive layer 11 and the conductive layer 15 and is electrically insulated from the self-emissive layer 11 and the conductive layer 15 through the insulation layer 12 and the insulation layer 14 respectively. The loading reduce layer 13 can be formed in a whole surface structure and can completely cover the self-emissive layer 11 located below. The loading reduce layer 13 can also be formed as a mesh-type electrode or an electrode with other geometric patterns through a pattern design.

The loading reduce layer 13 may be driven by a voltage signal such as an alternating current (AC) signal or a touch electrode related signal. The loading reduce layer 13 and the conductive layer 15 are driven simultaneously for at least a part of time and the loading reduce layer 13 can be in a floating state for another part of time. It should be noted that, during the conductive layer 15 is driven to perform touch sensing, the loading reduce layer 13 located below is also driven simultaneously for at least a part of time, so that the parasitic capacitance between the conductive layer 15 as the touch sensing electrode and ground can be reduced, so that the touch driving loading can be reduced, and the charging and discharging time of the capacitance during touch sensing can be also shortened. Therefore, the touch sensing driving frequency and the signal-to-noise ratio (SNR) can be effectively increased.

In another embodiment, as shown in FIG. 2, the laminated structure 2 of the pixel of the on-cell capacitive touch panel can include a substrate 20, a self-emissive layer 21, an insulation layer 22, a loading reduce layer 23, an encapsulation layer 24, a conductive layer 25, a polarizer 26, an adhesive layer 27 and a cover lens 28 from bottom to top. Wherein, the self-emissive layer 21 is disposed above the substrate 20. The encapsulation layer 24 is disposed above the self-emissive layer 21 with respect to the substrate 20. The loading reduce layer 23 is disposed above the self-emissive layer 21. The conductive layer 25 is disposed above the loading reduce layer 23 and above the encapsulation layer 24. The insulation layer 22 is disposed between the loading reduce layer 23 and the self-emissive layer 21. The polarizer 26 is disposed between the conductive layer 25 and the cover lens 28. The adhesive layer 27 is disposed between the polarizer 26 and the cover lens 28.

In practical applications, the self-emissive layer 21 can include an OLED laminated structure. The conductive layer 25 can be driven by a touch driving signal as a touch sensing electrode, and can be applied to self-capacitive touch sensing technology or mutual-capacitive touch sensing technology.

The loading reduce layer 23 is disposed between the self-emissive layer 21 and the conductive layer 25 and is electrically insulated from the self-emissive layer 21 and the conductive layer 25 through the insulation layer 22 and the insulation layer 24 respectively. The loading reduce layer 23 can be formed in a whole surface structure and can completely cover the self-emissive layer 21 located below. The loading reduce layer 23 can also be formed as a mesh-type electrode or an electrode with other geometric patterns through a pattern design.

The loading reduce layer 23 can be driven by a voltage signal such as an alternating current (AC) signal or a touch electrode related signal. The loading reduce layer 23 and the conductive layer 25 are driven simultaneously for at least a part of time and the loading reduce layer 23 can be in a floating state for another part of time. It should be noted that, during the conductive layer 25 is driven to perform touch sensing, the loading reduce layer 23 located below is also driven simultaneously for at least a part of time, so that the parasitic capacitance between the conductive layer 25 as the touch sensing electrode and ground can be reduced, so that the touch driving loading can be reduced, and the charging and discharging time of the capacitance during touch sensing can be also shortened. Therefore, the touch sensing driving frequency and the SNR can be effectively increased.

In another embodiment, as shown in FIG. 3, the laminated structure 3 of the pixel of the on-cell capacitive touch panel can include a substrate 30, a self-emissive layer 31, the encapsulation layer 32, a loading reduce layer 33, an insulation layer 34, a conductive layer 35, a polarizer 36, an adhesive layer 37 and a cover lens 38 from bottom to top. Wherein, the self-emissive layer 31 is disposed above the substrate 30. The encapsulation layer 32 is disposed above the self-emissive layer 31 with respect to the substrate 30. The loading reduce layer 33 is disposed above the self-emissive layer 31. The conductive layer 35 is disposed above the loading reduce layer 33 and above the encapsulation layer 32. The insulation layer 34 is disposed between the loading reduce layer 33 and the conductive layer 35. The polarizer 36 is disposed between the conductive layer 35 and the cover lens 38. The adhesive layer 37 is disposed between the polarizer 36 and the cover lens 38.

The laminated structure 3 shown in FIG. 3 and the laminated structure 2 shown in FIG. 2 are both on-cell structure, the only difference between them is that the loading reduce layer 23 is disposed under the encapsulation layer 24 in the laminated structure 2, but the loading reduce layer 33 is disposed above the encapsulation layer 32 in the laminated structure 3.

Similarly, during the conductive layer 35 is driven to perform touch sensing, the loading reduce layer 33 located below is also driven simultaneously for at least a part of time, so that the parasitic capacitance between the conductive layer 35 as the touch sensing electrode and ground can be reduced, so that the touch driving loading can be reduced, and the charging and discharging time of the capacitance during touch sensing can be also shortened. Therefore, the touch sensing driving frequency and the SNR can be effectively increased.

In another embodiment, as shown in FIG. 4, the laminated structure 4 of the pixel of the OGS capacitive touch panel can include a substrate 40, a self-emissive layer 41, the encapsulation layer 42, a loading reduce layer 43, a polarizer 44, an adhesive layer 45, a conductive layer 46 and a cover lens 47 from bottom to top. Wherein, the self-emissive layer 41 is disposed above the substrate 40. The encapsulation layer 42 is disposed above the self-emissive layer 41 with respect to the substrate 40. The loading reduce layer 43 is disposed above the self-emissive layer 41. The conductive layer 46 is disposed above the loading reduce layer 43, above the encapsulation layer 42 and under the cover lens 47. The loading reduce layer 43 and the self-emissive layer 41 are insulated from each other through the encapsulation layer 42. The loading reduce layer 43 and the conductive layer 46 are insulated from each other through the polarizer 44 and the adhesive layer 45. The adhesive layer 45 is disposed between the polarizer 44 and the conductive layer 46.

In practical applications, the self-emissive layer 41 can include an OLED laminated structure. The conductive layer 46 can be formed above the encapsulation layer 42 (e.g., under the cover lens 47) using an integration technology. The conductive layer 46 can be driven by a touch driving signal as a touch sensing electrode, and can be applied to self-capacitive touch sensing technology or mutual-capacitive touch sensing technology. The loading reduce layer 23 can be formed at any layer between the self-emissive layer 41 and the conductive layer 46. The loading reduce layer 43 can be formed in a whole surface structure and can completely cover the self-emissive layer 41 located below. The loading reduce layer 43 can also be formed as a mesh-type electrode or an electrode with other geometric patterns through a pattern design.

The loading reduce layer 43 can be driven by a voltage signal such as an AC signal or a touch electrode related signal. The loading reduce layer 43 and the conductive layer 46 are driven simultaneously for at least a part of time and the loading reduce layer 43 can be in a floating state for another part of time. It should be noted that, during the conductive layer 46 is driven to perform touch sensing, the loading reduce layer 43 located below is also driven simultaneously for at least a part of time, so that the parasitic capacitance between the conductive layer 46 as the touch sensing electrode and ground can be reduced, so that the touch driving loading can be reduced, and the charging and discharging time of the capacitance during touch sensing can be also shortened. Therefore, the touch sensing driving frequency and the SNR can be effectively increased.

In another embodiment, as shown in FIG. 5, the laminated structure 5 of the pixel of the OGS capacitive touch panel can include a substrate 50, a self-emissive layer 51, the encapsulation layer 52, a polarizer 53, a loading reduce layer 54, an adhesive layer 55, a conductive layer 56 and a cover lens 57 from bottom to top. Wherein, the self-emissive layer 51 is disposed above the substrate 50. The encapsulation layer 52 is disposed above the self-emissive layer 51 with respect to the substrate 50. The loading reduce layer 54 is disposed above the self-emissive layer 51. The conductive layer 56 is disposed above the loading reduce layer 54, above the encapsulation layer 52 and under the cover lens 57. The loading reduce layer 54 and the self-emissive layer 51 are insulated from each other through the polarizer 53 and the encapsulation layer 52. The loading reduce layer 54 and the conductive layer 56 are insulated from each other through the adhesive layer 55.

The laminated structure 5 shown in FIG. 5 and the laminated structure 4 shown in FIG. 4 are both OGS structure, the only difference between them is that the loading reduce layer 43 is disposed under the polarizer 44 in the laminated structure 4, but the loading reduce layer 54 is disposed above the polarizer 53 in the laminated structure 5.

Similarly, during the conductive layer 56 is driven to perform touch sensing, the loading reduce layer 54 located below is also driven simultaneously for at least a part of time, so that the parasitic capacitance between the conductive layer 56 as the touch sensing electrode and ground can be reduced, so that the touch driving loading can be reduced, and the charging and discharging time of the capacitance during touch sensing can be also shortened. Therefore, the touch sensing driving frequency and the SNR can be effectively increased.

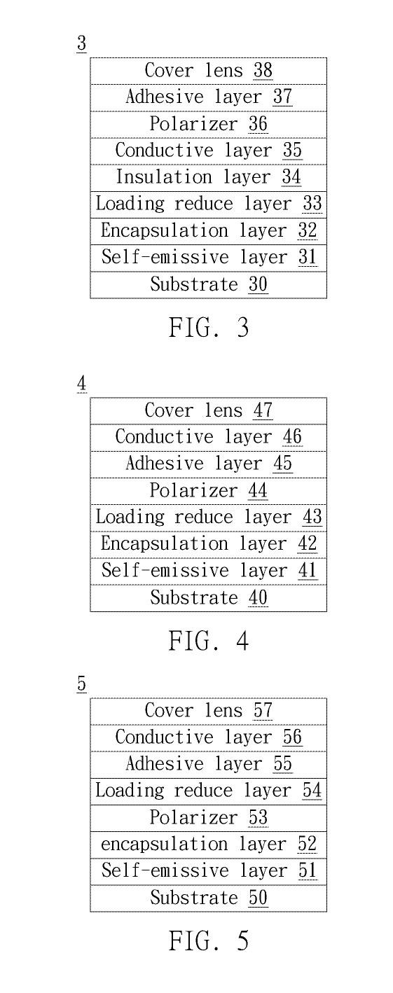

Please refer to FIG. 6. As shown in FIG. 6, the loading reduce layer LRL, disposed between the conductive layer TSL used as touch sensing layer and the self-emissive layer OLED used as display layer, can be formed as a whole sheet of transparent electrode, and the loading reduce layer LRL will overlap the conductive layer TSL and the self-emissive layer OLED in vertical direction.

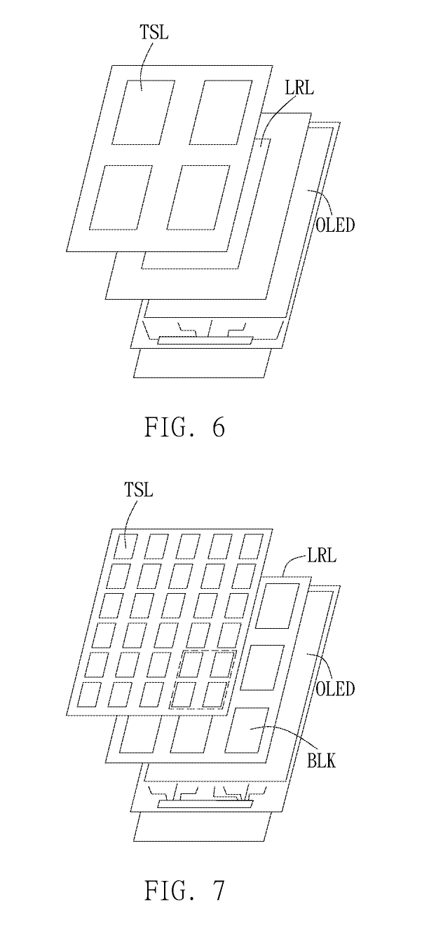

Please refer to FIG. 7. As shown in FIG. 7, the loading reduce layer LRL, disposed between the conductive layer TSL used as touch sensing layer and the self-emissive layer OLED used as display layer, can be divided into a plurality of blocks BLK and each block BLK will overlap a part of the conductive layer TSL and a part of the self-emissive layer OLED in vertical direction.

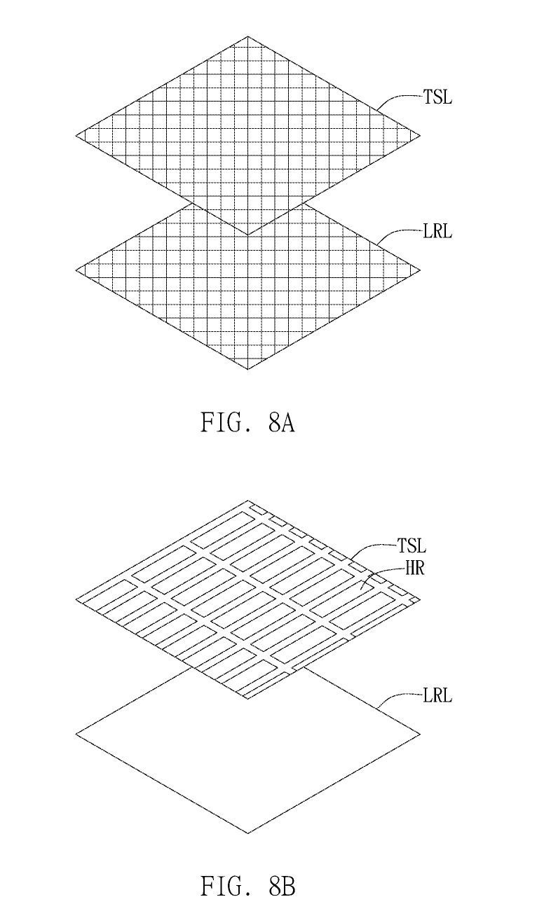

Please refer to FIG. 7. As shown in FIG. 8A, the conductive layer TSL and the loading reduce layer LRL can be both formed by transparent electrode or metal electrode in mesh shape, and the conductive layer TSL in mesh shape and the loading reduce layer LRL in mesh shape can be aligned with each other in vertical direction to provide the maximum loading reducing effect. In fact, the conductive layer TSL in mesh shape and the loading reduce layer LRL in mesh shape can be only partially overlapped with each other in vertical direction.

In fact, it can be only one of the conductive layer TSL and the loading reduce layer LRL formed in mesh shape. For example, as shown in FIG. 8B, the conductive layer TSL is formed in mesh shape, but the loading reduce layer LRL is formed as a whole surface structure.

In order to maintain the uniformity of the screen displayed by the capacitive touch panel, a floating electrode FE can be disposed in void regions HR of the mesh shape. The floating electrode FE is insulated from the conductive layer TSL and the loading reduce layer LRL and the he floating electrode FE is maintained in the floating state.

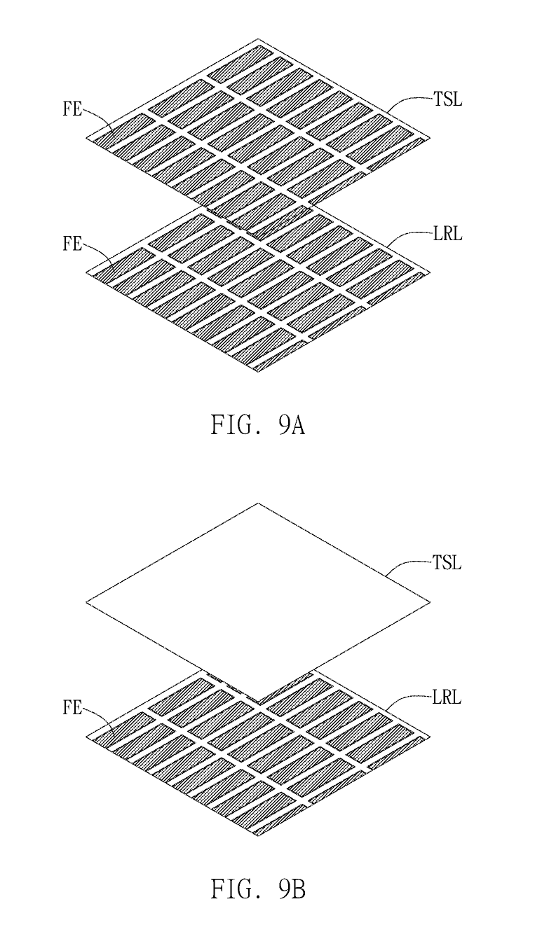

For example, as shown in FIG. 9A, the conductive layer TSL and the loading reduce layer LRL are both formed in mesh shape. The floating electrodes FE can be disposed in void regions HR of the mesh shape of the conductive layer TSL and the loading reduce layer LRL to maintain the uniformity of the screen displayed by the capacitive touch panel. The floating electrode FE is insulated from the conductive layer TSL and the loading reduce layer LRL and the he floating electrode FE is maintained in the floating state.

For example, as shown in FIG. 9B, only the loading reduce layer LRL is formed in mesh shape and the conductive layer TSL is formed as a whole surface structure. The floating electrodes FE can be disposed in void regions HR of the mesh shape of the loading reduce layer LRL to maintain the uniformity of the screen displayed by the capacitive touch panel. The floating electrode FE is insulated from the loading reduce layer LRL and the he floating electrode FE is maintained in the floating state.

In practical applications, when the conductive layer TSL is driven by a touch driving signal STD to be a touch sensing electrode, the loading reduce layer LRL is also driven by a loading reduce driving signal SLD simultaneously at least for a part of time, and the loading reduce driving signal SLD and the touch driving signal STD can have the same frequency and the same phase. In addition, the voltage level of the loading reduce driving signal SLD can be equal to, higher than or lower than the voltage level of the touch driving signal STD or be a combination of the above-mentioned different voltage levels.

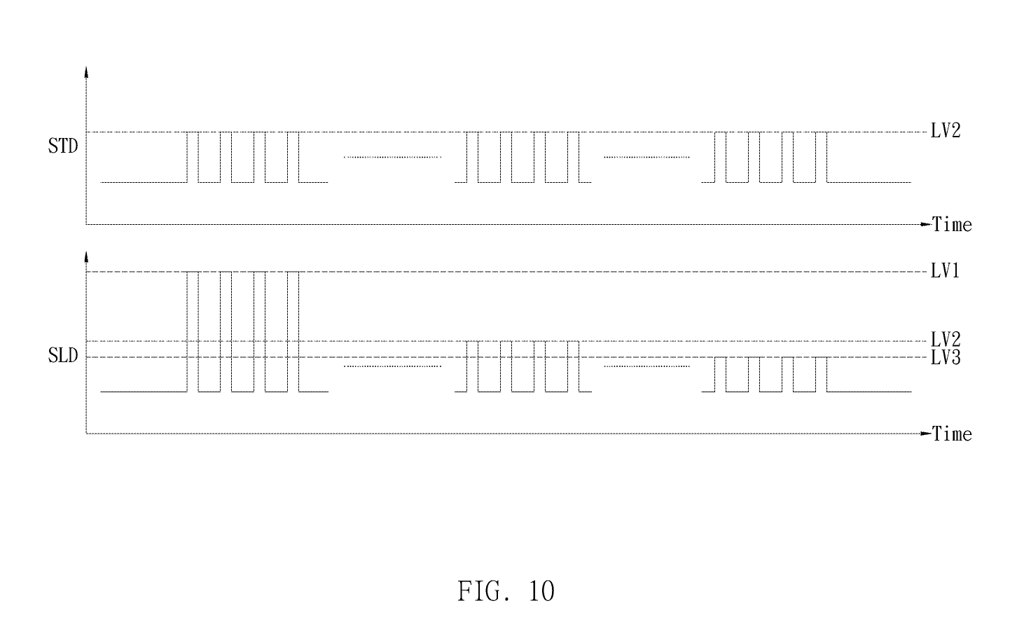

For example, as shown in FIG. 10, the voltage levels of the loading reduce driving signal SLD includes a combination of a voltage level LV1 higher than the touch driving signal STD, a voltage level LV2 equal to the touch driving signal STD and a voltage level LV3 lower than the touch driving signal STD in order.

If the loading reduce layer LRL is divided into a plurality of blocks BLK and each block BLK overlaps a part of the conductive layer TSL in vertical direction. When the conductive layer TSL is driven by a touch driving signal to be a touch sensing electrode, each block BLK of the loading reduce layer LRL, corresponding to the part of the conductive layer TSL overlapped, is driven by a loading reduce driving signal SLD in a partitioning way, and the loading reduce driving signal SLD and the touch driving signal STD have the same frequency and the same phase.

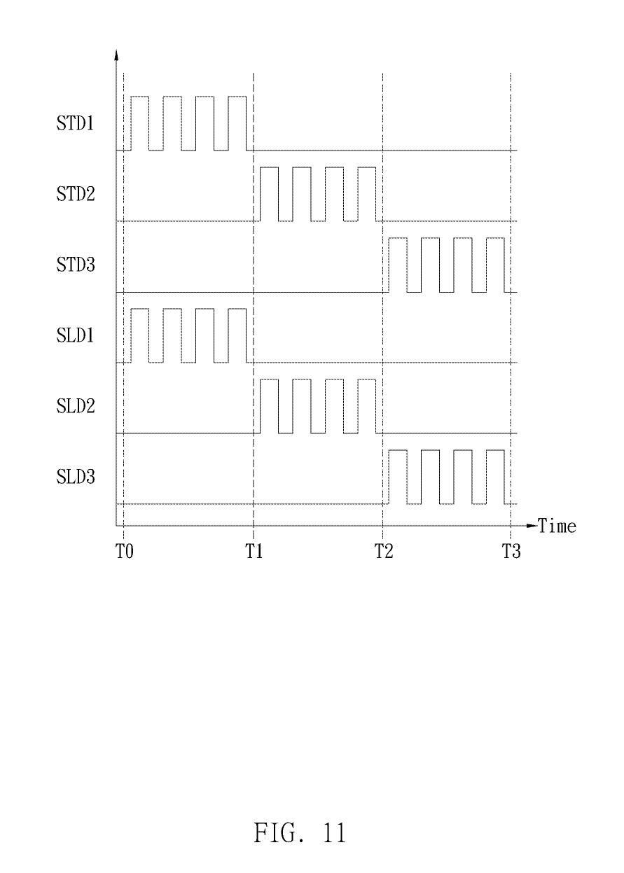

For example, as shown in FIG. 11, if a first touch driving signal STD1, a second touch driving signal STD2 and a third touch driving signal STD3 drive a first part, a second part and a third part of the conductive layer TSL respectively at different times, and a first block, a second block and a third block of the loading reduce layer LRL overlap the first part, the second part and the third part of the conductive layer TSL in vertical direction respectively, then the first block, the second block and the third block of the loading reduce layer LRL can be driven by a first loading reduce driving signal SLD1, a second loading reduce driving signal SLD2 and a third loading reduce driving signal SLD3 respectively in a partitioning way. The first loading reduce driving signal SLD1, the second loading reduce driving signal SLD2 and the third loading reduce driving signal SLD3 have the same frequency and the second phase with the first touch driving signal STD1, the second touch driving signal STD2 and the third touch driving signal STD3 respectively.

That is to say, during a period from the time T0 to the time T1, when the first part of the conductive layer TSL is driven by the first touch driving signal STD1, the corresponding first block of the loading reduce layer LRL will be driven by the first loading reduce driving signal SLD1; during a period from the time T1 to the time T2, when the second part of the conductive layer TSL is driven by the second touch driving signal STD2, the corresponding second block of the loading reduce layer LRL will be driven by the second loading reduce driving signal SLD2; during a period from the time T2 to the time T3, when the third part of the conductive layer TSL is driven by the third touch driving signal STD3, the corresponding third block of the loading reduce layer LRL will be driven by the third loading reduce driving signal SLD3.

Compared to the prior arts, the capacitive touch panel of the invention can be used in any self-luminous display (e.g., the OLED display, but not limited to this) and suitable for mutual-capacitive touch sensing technology or self-capacitive touch sensing technology. The capacitive touch panel of the invention can provide novel laminated structure and layout to effectively reduce parasitic capacitance and touch driving loading. Therefore, the touch sensing driving frequency and signal-to-noise ratio of the capacitive touch panel can be increased and the entire performance of the capacitive touch panel can be also enhanced.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A capacitive touch panel, comprising:
a plurality of pixels, a laminated structure of each pixel from bottom to top comprising:
a substrate;
a self-emissive layer disposed above the substrate;
an encapsulation layer, opposite to the substrate, disposed above the self-emissive layer;
a loading reduce layer disposed above the self-emissive layer; and
a conductive layer disposed above the loading reduce layer.

2. The capacitive touch panel of claim 1, wherein the conductive layer is used as touch sensing electrode suitable for mutual-capacitive touch sensing technology or self-capacitive touch sensing technology.

3. The capacitive touch panel of claim 1, wherein the self-emissive layer comprises an organic light-emitting diode (OLED) laminated structure.

4. The capacitive touch panel of claim 1, wherein the conductive layer is disposed under the encapsulation layer.

5. The capacitive touch panel of claim 4, wherein the conductive layer and the loading reduce layer are insulated from each other; the loading reduce layer and the self-emissive layer are insulated from each other.

6. The capacitive touch panel of claim 1, wherein the conductive layer is disposed above the encapsulation layer.

7. The capacitive touch panel of claim 6, wherein the loading reduce layer is disposed between the conductive layer and the encapsulation layer, and the conductive layer and the loading reduce layer are insulated from each other.

8. The capacitive touch panel of claim 6, wherein the loading reduce layer is disposed under the encapsulation layer, and the loading reduce layer and the self-emissive layer are insulated from each other.

9. The capacitive touch panel of claim 6, further comprising:
a cover lens, disposed above the conductive layer.

10. The capacitive touch panel of claim 9, wherein the loading reduce layer is disposed under the encapsulation layer, and the loading reduce layer and the self-emissive layer are insulated from each other.

11. The capacitive touch panel of claim 9, wherein the loading reduce layer is disposed above the encapsulation layer, and the loading reduce layer and the conductive layer are insulated from each other.

12. The capacitive touch panel of claim 11, further comprising:
a polarizer disposed between the encapsulation layer and the cover lens.

13. The capacitive touch panel of claim 12, wherein the polarizer is disposed between the loading reduce layer and the conductive layer.

14. The capacitive touch panel of claim 12, wherein the polarizer is disposed between the encapsulation layer and the loading reduce layer.

15. The capacitive touch panel of claim 1, wherein the loading reduce layer, formed as a whole sheet of transparent electrode, overlaps the conductive layer and the self-emissive layer in vertical direction.

16. The capacitive touch panel of claim 1, wherein the loading reduce layer is divided into a plurality of blocks and each block overlaps a part of the conductive layer in vertical direction.

17. The capacitive touch panel of claim 1, wherein the conductive layer and the loading reduce layer are formed as transparent electrode or metal electrode in mesh shape.

18. The capacitive touch panel of claim 17, wherein the conductive layer in mesh shape and the loading reduce layer in mesh shape are aligned with each other in vertical direction.

19. The capacitive touch panel of claim 17, wherein the conductive layer in mesh shape and the loading reduce layer in mesh shape are only partially overlapped with each other in vertical direction.

20. The capacitive touch panel of claim 1, wherein the conductive layer or the loading reduce layer is formed as transparent electrode or metal electrode in mesh shape, and a floating electrode is disposed in void regions of the mesh shape.

21. The capacitive touch panel of claim 1, wherein when the conductive layer is driven by a touch driving signal to be a touch sensing electrode, the loading reduce layer is also driven by a loading reduce driving signal simultaneously at least for a part of time, and the loading reduce driving signal and the touch driving signal have the same frequency and the same phase.

22. The capacitive touch panel of claim 20, wherein the loading reduce driving signal is an AC signal or a touch electrode related signal.

23. The capacitive touch panel of claim 20, wherein the loading reduce layer is in floating state for another part of time.

24. The capacitive touch panel of claim 16, wherein when the conductive layer is driven by a touch driving signal to be a touch sensing electrode, each block of the loading reduce layer, corresponding to the part of the conductive layer overlapped, is driven by a loading reduce driving signal in a partitioning way, and the loading reduce driving signal and the touch driving signal have the same frequency and the same phase.
